(19) United States
(12) Patent Application Publication
(10) Pub. No.: US 2018/0272636 A1
(43) Pub. Date: Sep. 27, 2018

(54) PRESSURIZATION APPARATUS FOR PREVENTING FAULTY FORMATION PATTERN OF TIRE

(71) Applicant: MK TECHNOLOGY CORP., Daejeon (KR)

(72) Inventors: Yong Sup KIM, Daejeon (KR); Ji Hyung LEE, Sejong-si (KR)

(73) Assignee: MK TECHNOLOGY CORP., Daejeon (KR)

(21) Appl. No.: 15/838,589

(22) Filed: Dec. 12, 2017

(30) Foreign Application Priority Data
Mar. 27, 2017 (KR) 10-2017-0038391

(51) Int. Cl. B29D 30/06; B29C 35/04

(52) U.S. Cl. CPC B29D 30/0605; B29D 2030/0022; B29D 30/0603; B29C 35/049

(57) ABSTRACT

A pressurization apparatus for preventing faulty formation of patterns of a tire includes a push part for pressing the upper surface of a green tire and fixing the green tire and configured to be separated at the center and located under an upper plate with closely contact with the upper plate; an upper plate formed on the upside of the push part; a press part being located under the upper plate and coupled with the external sides thereof; a pattern part formed to contact the inner surface of the press part and operated to slide and move up or down; and a support part placed under the green tire to contact with the lower surface of the green tire and to support the green tire.

### CROSS-REFERENCE TO RELATED APPLICATION

This application claims priority under 35 U.S.C. § 119 to Korean Patent Application No. 10-2017-0038391 filed on Mar. 27, 2017, the disclosure of which is hereby incorporated by reference in its entirety.

### BACKGROUND

### 1. Field

Embodiments of the present invention relate to a pressurization apparatus for preventing faulty formation of patterns of a tire, and more particularly, to a pressurization apparatus for preventing faulty formation of patterns of a tire by simplifying the structure of its push part and its support part, making its assembling and maintenance simple and convenient, and preventing the splaying of its press part since the bound portion of the press part and the fix portion of the support part are engaged and coupled with each other, and thereby, the pattern part can be uniformly pressurized.

### 2. Description of Related Art

A tire curing container generally receives supplied green tires, applies pressure and temperature thereon, and forms protrusions or logs on the tire tread and the side surface of a tire, thereby to produce complete tire products.

The tire curing container of prior art includes an up-down and side mold for molding the side surface of a tire, a tread mold for molding the tread portion of a tire with located between the side molds, upper plate and lower plate for supporting the side mold, a segment for transferring the heat transmitted through a steam chamber part formed on an exterior ring to the tread mold while supporting the tread mold, and the exterior ring for moving the segment horizontally with connected to the outside of the segment.

Here, the segment can be moved front or back along the up/down operation of the exterior ring. In order to facilitate this movement easily, the external side surface of the segment is formed with inclined which becomes narrow toward the upside, and the internal side surface of the exterior ring is formed with inclined to correspond to the external side surface of the segment. Therefore, the segment is formed thicker at its lower portion than its upper portion.

The steam chamber part is formed in circular shape, and is formed such that its inner shape has an inclined surface to correspond with the inclined internal side surface of the exterior ring and the inclined external side surface of the segment, so that its lower portion has smaller measurement of volume than its upper portion.

Therefore, during the process that the heat of the steam introduced into the steam chamber part is transferred to the tread mold through the segment, the heat transmission to the lower portion of the segment, which is thicker, is disadvantageous compared with to its upper portion, thereby producing the problems of miscure at the lower portion in the tread mold during curing process.

Further, normal and sufficient pressure cannot be transferred to the segment when the upper portion of the exterior ring which is formed on the outside of the segment is abraded because of repeated and continuous up and down movement of the segment, thereby occurring problems of failing tread formation to be normally formed on a green tire.

One of the prior arts in order to solve these problems discloses that the difference of measurement of volume is made to be decreased at the upper portion and the lower portion, thereby to increase the efficiency of heat transmission toward the lower portion of the segment which is greater in the thickness, and to prevent the occurrence of miscure at the lower portion of the tread mold during curing process, and to provide the steam chamber part which enables to maintain the heat of the inwardly introduced steam.

However, the related patent of prior art still has the problem of failing in the formation of normal treads on a green tire completely because normal sufficient pressures cannot be transferred to the segment when the upper portion of the exterior ring formed on the outside of the segment comes to be abraded during the continuous and repeated up/down movement of the segment.

### PRIOR ART DOCUMENT

(patent 1) Korean Patent Publication 10-1357717 (Jan. 24, 2014)

### SUMMARY

Embodiments of the present invention provide a pressurization apparatus for preventing faulty formation of patterns of a tire by simplifying the structure of its push part and its support part, making its assembling and maintenance simple and convenient, and preventing the splaying of its press part since the bound portion of the press part and the fix portion of the support part are engaged and coupled with each other, and thereby, the pattern part can be uniformly pressurized.

In accordance with an aspect of the present invention, the pressurization apparatus for preventing faulty formation of patterns of a tire may include including a push part for pressing the upper surface of a green tire and fixing the green tire, and configured to be separated at the center and located under an upper plate with closely contact with the upper plate, and operated to be elevated by an elevator independently from the upper plate; an upper plate formed on the upside of the push part, so as to fix a press part and having an elevating member being coupled on the upside thereof; a press part being located under the upper plate and coupled with the external sides thereof, and formed in a diagonal shape at its inner peripheral surface so as to apply pressure internally when the upper plate moves down, and having a bound portion formed on its lower end; a pattern part formed to contact the inner surface of the press part and operated to slide and move up or down, and formed of a plurality of pieces, and applying pressure on the external surface of the green tire when moving up or down so as to form patterns on the green tire; and a support part placed under the green tire to contact with the lower surface of the green tire and to support the green tire, and having a fix portion formed externally and upwardly to correspond with the bound portion formed on the lower end of the press part, and having an insertion groove into which a lower end of the pattern part is inserted, and being coupled with and fixed to the upside of a lower plate.

The press part may be formed such that its internal surface is downwards inclined toward outside in a diagonal direction for the pattern part to enable to slide and be elevated up or down, and may have the bound portion formed on its lower end with a step which is coupled with the fix portion formed on the upside of the support part to correspond with the bound portion formed on the lower end of the press part, and the vertical contact surface coupled with the fix portion may be formed in diagonal line or semielliptical shape.

The pattern part may be formed of a plurality of pieces, so that the pattern part slides and is elevated up or down while contacted with the internal surface of the press part, and is inwardly tightened when the press part moves down, and may be formed in a diagonal line shape gradually widened downwards toward the exterior to correspond with the contact surface of the press part, and may have its lower end protruded and contact with the sidewall of the insertion groove of the support part not to be pressurized toward the support part further than necessary.

The bound portion may be formed to be protruded downwards from the internal direction lower end of the press part, and may have the contact surface formed with a predetermined angle in linear or curved line toward internal downside along the diagonal direction, and its upper internal surface may be formed in linear or curved line shape along the diagonal direction to correspond with the fix portion of the support part coupled with the bound portion, and by the bound portion caught by the fix portion, the lower end of the press part may be prevented from externally distanced apart, thereby to prevent the pattern part from not being pressurized.

The pressurization apparatus for preventing faulty formation of patterns of a tire of the present invention provides the advantage of simplifying the structure of its push part and its support part, making its assembling and maintenance simple and convenient.

Further, the pressurization apparatus for preventing faulty formation of patterns of a tire of the present invention also provides the advantage of preventing the splaying of its press part since the bound portion of the press part and the fix portion of the support part are engaged and coupled with each other, thereby to uniformly pressurize the pattern part.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The foregoing and other features and advantages of the present inventions will be apparent from the more particular description of preferred embodiments of the present inventions, as illustrated in the accompanying drawings in which like reference characters refer to the same parts throughout the different views. The drawings are not necessarily to scale, emphasis instead being placed upon illustrating the principles of the present inventions. In the drawings:

FIG. 1 is a sectional view showing the entire configuration of a pressurization apparatus for preventing faulty formation of patterns of a tire according to an embodiment of the present invention;

FIG. 2 is a view showing that a press part and a push part are elevated up and a green tire is inserted inwardly in a pressurization apparatus for preventing faulty formation of patterns of a tire according to an embodiment of the present invention;

FIG. 3 is a view showing that a press part is elevated up and a tire is supported by a support part and a push part and a pattern part are placed down in a pressurization apparatus for preventing faulty formation of patterns of a tire according to an embodiment of the present invention;

FIG. 4 is a view showing that an elevator is moved down, and a pattern part is made to contact with a support part in a pressurization apparatus for preventing faulty formation of patterns of a tire according to an embodiment of the present invention; and

FIG. 5 is a view showing that a press part is completely moved down, so as to press a pattern part and form patterns on a green tire in a pressurization apparatus for preventing faulty formation of patterns of a tire according to an embodiment of the present invention.

### DETAILED DESCRIPTION OF THE EMBODIMENTS

Since exemplary embodiments of the present invention are provided only for structural and functional descriptions of the present invention, the present invention should not be construed as limited to the embodiments set forth herein. Thus, it will be clearly understood by those skilled in the art that the exemplary embodiments of the present invention may be embodied in different forms and include equivalents that can realize the spirit of the present invention. It should be understood, however, that it is not intended to limit the present invention to the particular forms disclosed, but on the contrary, the present invention is to cover all modifications, equivalents, and alternatives falling within the spirit and scope of the present invention as defined by the appended claims.

It will be understood that, although the terms first, second, etc. may be used herein to describe various elements, components and/or sections, these elements, components, and/or sections should not be limited by these terms. These terms are only used to distinguish one element, component or section from another ones. Thus, a first element, component or part discussed below could be termed a second element, component or part without departing from the teachings of the present invention.

It will be understood that when an element or part is referred to as being “connected to” or “coupled to” another element or part, it can be directly connected or coupled to the other element or part or intervening elements or parts may be present. In contrast, when an element is referred to as being “directly connected to” or “directly coupled to” another element or part, there are no intervening elements or parts present. Meanwhile, spatially relative terms, such as “between” and “directly between” or “adjacent to” and “directly adjacent to” and the like, which are used herein for ease of description to describe one element or feature's relationship to another element(s) or feature(s) as illustrated in the figures, should be interpreted similarly.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. Terms indicating directions of apparatuses or elements (such as “front”, “back”, “up”, “down”, “top”, “bottom”, “left”, “right”, and “lateral”) are used to simplify description of the invention and do not represent nor mean that the apparatuses or elements have specific directions. It will be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Unless expressly defined in a specific order herein, respective steps described in the present invention may be performed otherwise. That is, the respective steps may be performed in a specified order, substantially at the same time, or in reverse order.

The present invention will now be described more fully hereinafter with reference to the accompanying drawings, in which exemplary embodiments of the present invention are shown.

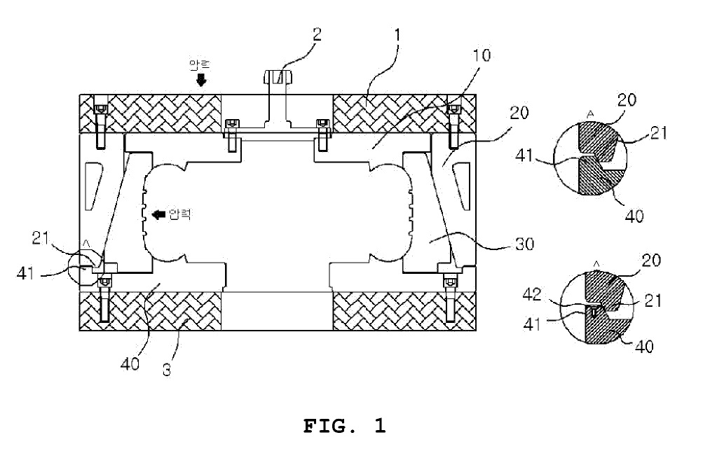

FIG. 1 shows the entire configuration of a pressurization apparatus for preventing faulty formation of patterns of a tire according to an embodiment of the present invention, the apparatus is structured by including a push part 10 for pressing the upper surface of a green tire 4 and fixing the green tire 4, and configured to be separated at the center and located under an upper plate 1 with closely contact with the upper plate 1, and operated to be elevated by an elevator 2 independently from the upper plate 1; an upper plate 1 formed on the upside of the push part 10, so as to fix a press part 20 and having an elevating member being coupled on the upside thereof; a press part 20 being located under the upper plate 1 and coupled with the external sides thereof, and formed in a diagonal shape at its inner peripheral surface so as to apply pressure internally when the upper plate 1 moves down, and having a bound portion 21 formed on its lower end; a pattern part 30 formed to contact the inner surface of the press part 20 and operated to slide and move up or down, and formed of a plurality of pieces, and applying pressure on the external surface of the green tire 4 when moving up or down so as to form patterns on the green tire 4; and a support part 40 placed under the green tire 4 to contact with the lower surface of the green tire 4 and to support the green tire 4, and having a fix portion 41 formed externally and upwardly to correspond with the bound portion 21 formed on the lower end of the press part 20, and having an insertion groove into which a lower end of the pattern part 30 is inserted, and being coupled with and fixed to the upside of a lower plate 3.

The green tire 4 here means a plane type tire without any pattern on its external surface.

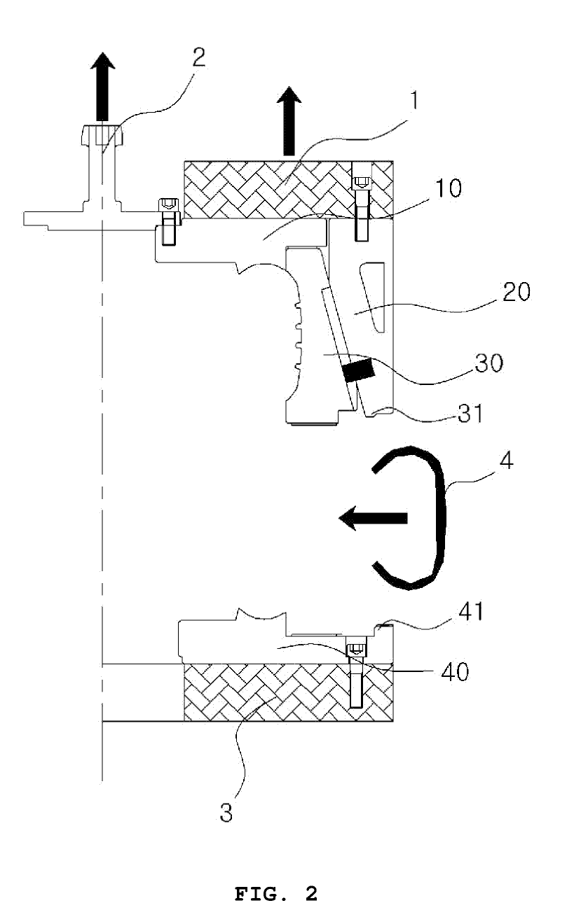

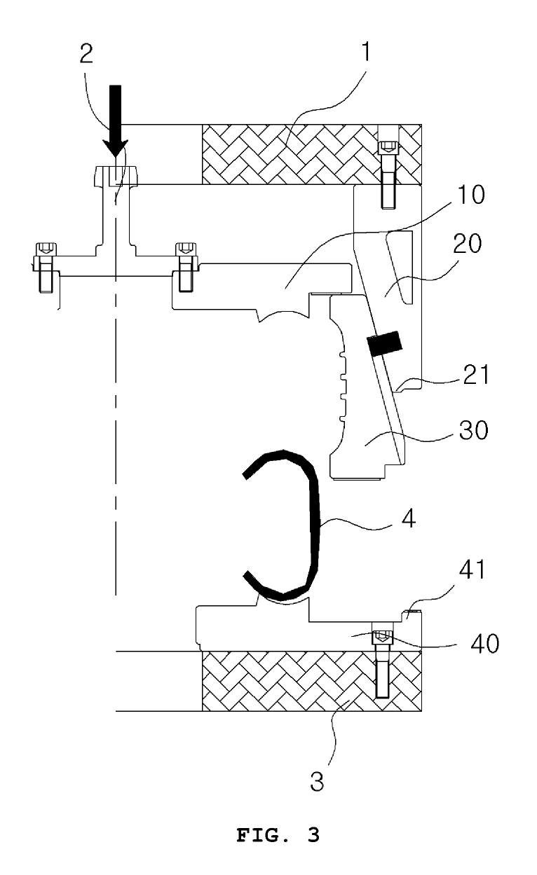

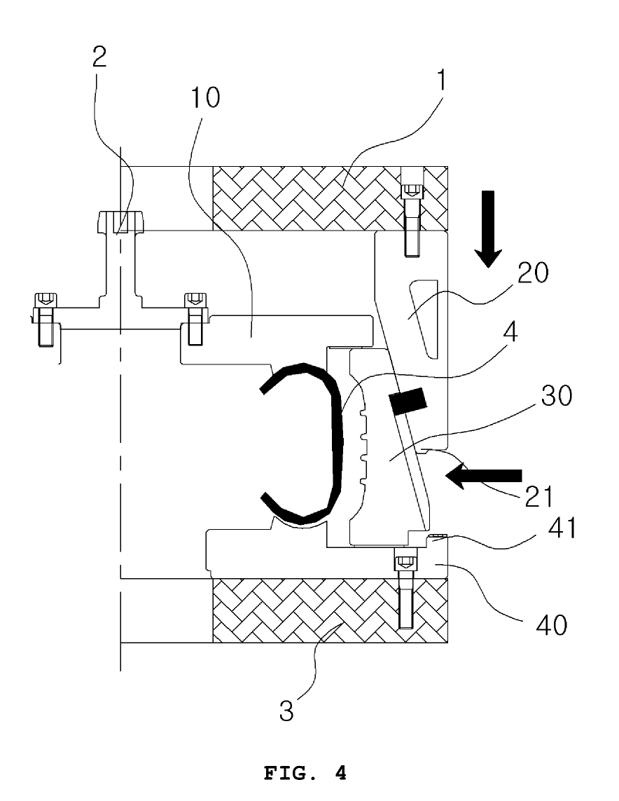

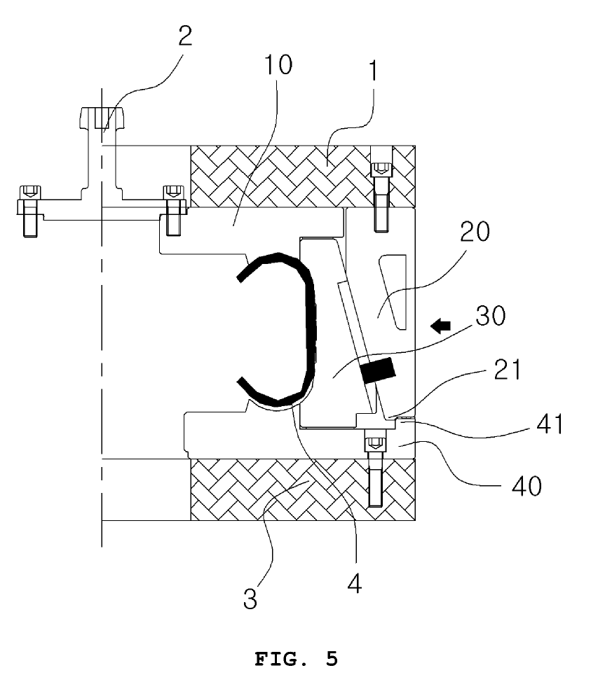

FIG. 2 is a view showing a pressurization apparatus for preventing faulty formation of patterns of a tire according to an embodiment of the present invention, in which its press part and its push part are elevated up and a green tire is internally inserted, FIG. 3 is a view showing a pressurization apparatus for preventing faulty formation of patterns of a tire according to an embodiment of the present invention, in which its press part is elevated up and a tire is supported by its support part, and its push part and its pattern part are moved down, FIG. 4 is a view showing a pressurization apparatus for preventing faulty formation of patterns of a tire according to an embodiment of the present invention, in which its elevator is moved down and its pattern part contacts with its support part, and FIG. 5 is a view showing a pressurization apparatus for preventing faulty formation of patterns of a tire according to an embodiment of the present invention, in which its press part is completely moved down to press the pattern part so as to form patterns on a green tire.

Referring to FIGS. 1 and 2, a push part 10 is located under an upper plate 1 to contact the lower surface of the upper plate 1 formed of a plate shape and having a hole at its center, and is elevated up or down by an elevator 2 along the internal surface of a press part 20 formed on the periphery of the upper plate 1 there under, and is configured to contact and be connected with the upper plate 1, and is shaped to be vertically separated in half at its center or to form one module with a plurality of pieces, and a push portion is formed to be downwardly protruded with the shape to correspond with the upper side surface of the green tire 4 so as to push and fix the green tire 4 downwards from upside.

The reason that the push part 10 is formed separately at its center in the vertical direction or formed of a plurality of pieces is because of injection molding through a metal mold.

A fix groove is formed at the exterior side of the push part 10, and the upper end of the rising pattern part 30 is safely mounted on, thereby to prevent the rising pattern part 30 from moving up into the push part 10 inwardly more than designed and necessary.

The upper plate 1 is coupled on the push part 10, and the press part 20 is coupled with the exterior side of the upper plate 1 there under, and thus, the press part 20 is formed in a cylindrical shape, and its inner peripheral surface is formed in a diagonal shape externally and downwards, and a bound portion 21 is formed on the lower end.

Referring to FIG. 3, the bound portion 21 is formed on the lower end of the press part 20 from which being downwards protruded with a step, and the surface of the step, which contacts with the fix portion 41 of the support part 40, is formed in diagonal line or semielliptical shape with a predetermined inclined angle.

When the contact surface is formed with an inclined angle in a diagonal direction, the contact surface is formed of a diagonal line while its lower side is more inwardly directed than its upper side. When the contact surface is formed in a semielliptical shape, the semielliptical shape is formed to be directed upwardly or downwardly, and thus, the contact surface of the fix portion 41 is formed corresponding thereto.

The lower end of the press part 20 can be prevented from being misplaced and separated outwards, and thus, can function to uniformly press the pattern part 30, because of the contact surface of the step of the bound portion 21 and the contact surface of the fix portion 41 which is shaped corresponding thereto, thereby preventing failures in the pattern formation which may occur when the pattern part 30 cannot press the green tire 4 entirely and completely.

The press part 20 is formed in the shape of a diagonal line toward the outside downwards at the inner peripheral surface where the press part 20 and the pattern part 30 contact.

The outer peripheral surface of the pattern part 30 is formed in the shape of a diagonal direction downwards and externally to correspond with the inner peripheral surface of the press part 20, and when the pattern part 30 slides and moves up or down in the diagonal direction along the inner surface of the press part 20 while being in contact with the inner peripheral surface of the press part 20, patterns are formed on the external surface of the green tire 4.

Referring to FIGS. 3 and 4, the pattern part 30 is formed of a plurality of pieces, and while covering the outside of the green tire 4, when the pattern part 30 is operated to move up or down along the inner side surface of the press part 20, the space gap between respective pieces of the pattern part 30 becomes narrow and closely and tightly contact with each other, thereby to form patterns on the external surface of the green tire 4.

When the pattern part 30 is elevated up or down while its upper side is inserted into the fix groove which is located at the external downside of the push part 10, the pattern part 30 can be prevented from moving inwardly further excessively than required and necessary, and its lower side is inserted into an insertion groove formed in the support part 40 so that it can be prevented from moving more inwardly than the side wall of the insertion groove of the support part 40.

The support part 40 has a support portion formed on its upper surface with protruded upwardly in the same shape corresponding to the lower surface shape of the green tire 4 to enable to support the green tire 4 to be mounted thereon, and the support part 40 also has the insertion groove formed outside the support portion for the lower end of the pattern part 30 to be inserted there into so that the pattern part 30 can be prevented from further inwardly moving than necessary due to the pressure of the press part 20 on the pattern part 30.

The fix portion 41 is formed on the peripheral upside of the support part 40, to correspond with the bound portion 21 of the press part 20, so that the bound portion 21 of the press part 20 slides and is bound, and the press part 20 can be prevented from being spaced apart outwards.

The contact surface that the fix portion 41 and the bound portion 21 of the press part 20 contact with each other is formed in a diagonal line or semielliptical shape to correspond with the bound portion 21, and the fix portion 41 contacts with the bound portion 21 slidingly, so as to prevent the press part 20 from being spaced apart outwards.

A prevention portion 42 is replaceably provided on the upper surface of the fix portion 41 in order to prevent the fix portion 41 from being worn out off at the contact surface with the bound portion 21 because of their touch and contact against each other.

The support part 40 is formed to be separated in half at the center or separated to pieces more than half, and is provided to be coupled and fixed on the upside of the lower plate 3 to form one body with contacted closely at its center.

The reason that the support part 40 is formed of a plurality of pieces as above is because of injection molding through a metal mold.

Therefore, a method of forming patterns on the surface of a green tire through the structure of the present invention described as above will now be described as below.

The upper plate 1 is moved up by using an elevating member formed on the upside of the upper plate 1, thereby to elevate up the press part 20 and make the pattern part 30 to be opened.

When the upper plate 1 is moved up, the push part 10, which is coupled with the pattern part 30, is made to be elevated up through the elevator 2 at the same time, and the green tire 4 is placed to be internally inserted, and is supported by the support portion on the upside of the support part 40. When the green tire 4 is completely mounted on and safely supported, the upper plate 1 and the push part 10 are made to be moved down by using the elevator 2 and the elevating member, and the pattern part 30, which is coupled and moved together with the push part 10, is opened and placed outside the green tire 4.

When the pattern part 30 is closely contacted with the upside of the support part 40, the upper plate 1 is made to be moved down, and thus, the press part 20 is made to apply pressure on the pattern part 30, so as to form patterns on the surface of the green tire 4.

When patterns formation is completed on the surface of the green tire 4, the green tire 4 is separated out and produced out through the processes of the method performed on the contrary to the above.

The pressurization apparatus for preventing faulty formation of patterns of a tire according to an embodiment of the present invention structured as above simplifies the structure of the push part and the support part, thereby providing effectives of components assembling and their maintenance of the apparatus being simple and convenient.

Further, in the pressurization apparatus for preventing faulty formation of patterns of a tire according to an embodiment of the present invention, the bound portion of the press part and the fix portion of the support part are tightly engaged together and coupled with each other, the press part can press the pattern part uniformly while the separation and spacing of the press part does not occur, thereby providing advantages of preventing failures of tire pattern formation.

The pressurization apparatus for preventing faulty formation of patterns of a tire of the present invention as above is not limited to the structure and the operation method of the embodiments described as above. Therefore, the embodiments of the present invention can be partially or entirely selected, and selectively employed, thereby providing various types of modifications of the present invention.

The foregoing is illustrative of embodiments and is not to be construed as limiting thereof. Although a few embodiments have been described, those skilled in the art will readily appreciate that many modifications are possible without materially departing from the novel teachings and advantages. Accordingly, all such modifications are intended to be included within the scope of this present invention as defined in the claims. In the claims, means-plus-function clauses are intended to cover the structures described herein as performing the recited function, and not only structural equivalents but also equivalent structures.

What is claimed is:

1. A pressurization apparatus for preventing faulty formation of patterns of a tire comprising:
a push part (10) for pressing the upper surface of a green tire (4) and fixing the green tire (4), and configured to be separated at the center and located under an upper plate (1) with closely contact with the upper plate (1), and operated to be elevated by an elevator (2) independently from the upper plate (1);
an upper plate (1) formed on the upside of the push part (10), so as to fix a press part (20) and having an elevating member being coupled on the upside thereof;
a press part (20) being located under the upper plate (1) and coupled with the external sides thereof, and formed in a diagonal shape at its inner peripheral surface so as to apply pressure internally when the upper plate (1) moves down, and having a bound portion (21) formed on its lower end;
a pattern part (30) formed to contact the inner surface of the press part (20) and operated to slide and move up or down, and formed of a plurality of pieces, and applying pressure on the external surface of the green tire (4) when moving up or down so as to form patterns on the green tire (4); and
a support part (40) placed under the green tire (4) to contact with the lower surface of the green tire (4) and to support the green tire (4), and having a fix portion (41) formed externally and upwardly to correspond with the bound portion (21) formed on the lower end of the press part (20), and having an insertion groove into which a lower end of the pattern part (30) is inserted, and being coupled with and fixed to the upside of a lower plate (3), wherein
the press part (20) is formed such that its internal surface is downwards inclined toward outside in a diagonal direction for the pattern part (30) to enable to slide and be elevated up or down, and has the bound portion (21) formed on its lower end with a step which is coupled with the fix portion (41) formed on the upside of the support part (40) to correspond with the bound portion (21) formed on the lower end of the press part (20), and the vertical contact surface coupled with the fix portion (41) is formed in diagonal line or semielliptical shape, and
the pattern part (30) is formed of a plurality of pieces, so that the pattern part (30) slides and is elevated up or down while contacted with the internal surface of the press part (20), and is inwardly tightened when the press part (20) moves down, and is formed in a diagonal line shape gradually widened downwards toward the exterior to correspond with the contact surface of the press part (20), and has its lower end protruded and contact with the sidewall of the insertion groove of the support part (40) not to be pressurized toward the support part (40) further than necessary, and
the bound portion (21) is formed to be protruded downwards from the internal direction lower end of the press part (20), and has the contact surface formed with a predetermined angle in linear or curved line toward internal downside along the diagonal direction, and its upper internal surface is formed in linear or curved line shape along the diagonal direction to correspond with the fix portion (41) of the support part (40) coupled with the bound portion (21), and by the bound portion (21) caught by the fix portion (41), the lower end of the press part (20) is prevented from externally distanced apart, thereby to prevent the pattern part (30) from not being pressurized, and
a prevention portion (42) is replaceably provided on the upper surface of the fix portion (41) in order to prevent the fix portion (41) from being worn out off at the contact surface with the bound portion (21) because of their touch and contact against each other.
